(19) United States
(12) Patent Application Publication
(10) Pub. No.: US 2022/0186109 A1
(43) Pub. Date: Jun. 16, 2022

(54) OPTICAL FILM, BACKLIGHT MODULE AND MANUFACTURING METHOD OF OPTICAL FILM

(71) Applicant: NAN YA PLASTICS CORPORATION, Taipei (TW)

(72) Inventors: TE-CHAO LIAO, Taipei (TW); CHUN-CHE TSAO, Taipei (TW); REN-YU LIAO, New Taipei City (TW)

(21) Appl. No.: 17/340,099

(22) Filed: Jun. 7, 2021

(30) Foreign Application Priority Data
Dec. 11, 2020 (TW) 109143756

(51) Int. Cl. C09K 11/02; F21V 8/00; C08L 33/04

(52) U.S. Cl. CPC C09K 11/02; G02B 6/0026; C08L 2203/20; C08L 2201/52; C08L 33/04

(57) ABSTRACT

An optical film, a backlight module and a manufacturing method of the optical film are provided. The optical film includes a quantum dot gel layer and a shielding layer disposed on the quantum dot gel layer. The quantum dot gel layer includes a first polymer and a plurality of quantum dots dispersed in the first polymer. The first polymer includes 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer, and 100 to 1200 ppm of inhibitor.

### CROSS-REFERENCE TO RELATED PATENT APPLICATION

This application claims the benefit of priority to Taiwan Patent Application No. 109143756, filed on Dec. 11, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical film, and more particularly to an optical film capable of being applied in a backlight module and an LED package.

### BACKGROUND OF THE DISCLOSURE

In recent years, with the development of display technology, people have higher requirements for the quality of displays. Quantum dots (QDs) have attracted wide attention from researchers due to their unique quantum confinement effects. Compared with conventional organic light-emitting materials, the luminous efficacy of the quantum dots has the advantages of having a narrow full width at half maximum (FWHM), small particles, no scattering loss, a spectrum that is adjustable with size, and a stable photochemical performance. In addition, the optical, electrical, and transmission properties of the quantum dots can be adjusted through a synthesis process. Such advantages have contributed to the importance of quantum dot technology, and polymer composite materials with quantum dots have been used in fields such as backlights and display devices in recent years.

However, the luminous efficiency of quantum dots is highly susceptible to oxygen, water vapor, etc. Conventionally, in optical film art, resin films are usually disposed on the front and back sides of a quantum dot film, or barrier films are further disposed on the quantum dot film, so as to improve an ability of the optical film to block water vapor and oxygen. However, costs and preparation time are increased due to the additional layer structure. Furthermore, a thickness of the final product cannot be reduced, so that the optical film cannot be applied to display devices other than televisions, and the application range of quantum dot technology on the display devices is limited.

Therefore, how to overcome the above-mentioned issues by improving the formulation of the quantum dot gel layer to omit the additional layer has become one of the important issues to be solved in this field.

### SUMMARY OF THE DISCLOSURE

In response to the above-referenced technical inadequacies, the present disclosure provides an optical film that has a shielding layer disposed on only one side of a quantum dot gel layer. Further, the present disclosure provides an optical film that includes a quantum dot gel layer and a shielding layer. The quantum dot gel layer has a first side and a second side, the shielding layer is disposed on the first side of the quantum dot gel layer, and the second side of the quantum dot gel layer is not covered.

In one aspect, the present disclosure provides an optical film that includes a quantum dot gel layer and a shielding layer disposed on the quantum dot gel layer. More specifically, the quantum dot gel layer includes a first polymer and a plurality of quantum dots dispersed in the first polymer, and based on a total weight of the quantum dot gel layer being 100 weight percent, the first polymer includes: 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer, and 100 to 1200 ppm of inhibitor.

In certain embodiments, the shielding layer further includes a chemical treated surface, and the shielding layer is disposed on the quantum dot gel layer through the chemical treated surface.

In certain embodiments, the optical film further includes a matte treated layer disposed on the shielding layer, so that the shielding layer is arranged between the quantum dot gel layer and the matte treated layer.

In certain embodiments, the thiol compound is selected from a group consisting of 2, 2′-(ethylenedioxy)diethyl mercaptan, 2,2′-thiodiethanethiol, trimethylolpropane tris(3-mercaptopropionate), poly(ethylene glycol) dithiol, pentaerythritol tetrakis(3-mercaptopropionate), ethylene glycol bis-mercaptoacetate, and ethyl 2-mercaptopropionate.

In certain embodiments, the monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate.

In certain embodiments, the multifunctional acrylic monomer is selected from a group consisting of trimethylolpropane triacrylate, trimethylolpropane trimethacrylate, ethoxylated (20) trimethylolpropane triacrylate, and pentaerythritol triacrylate.

In certain embodiments, the oligomer is selected from a group consisting of polycarbonate acrylate, urethane acrylate, and polybutadiene acrylate.

In certain embodiments, the inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol, triaryl phosphines, triaryl phosphites, phosphonic acid, and a combination of an alkenyl-phenol and cupferronate salt.

In another aspect, the present disclosure provides a manufacturing method of an optical film, the method includes: dispersing a plurality of quantum dots in a first polymer to form a quantum dot gel layer; providing a shielding layer that has a chemical treated surface, the shielding layer being disposed on one side of the quantum dot gel layer through the chemical treated surface; and based on a total weight of the quantum dot gel layer being 100 weight percent, the first polymer including: 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer, and 100 to 1200 ppm of inhibitor.

In certain embodiments, the manufacturing method of the optical film further includes forming a matte treated layer on the shielding layer, so that the shielding layer is arranged between the quantum dot gel layer and the matte treated layer.

In yet another aspect, the present disclosure provides a backlight module that includes a light guide unit, at least one light emitting unit and an optical unit. The light guide unit has a light entrance side. The at least one light emitting unit corresponds to the light entrance side. The optical unit corresponds to the light entrance side and is disposed between the light guide unit and the at least one light emitting unit. The optical unit includes a quantum dot gel layer and a shielding layer. The quantum dot gel layer includes a first polymer and a plurality of quantum dots dispersed in the first polymer. The shielding layer is disposed on the quantum dot gel layer. The first polymer includes: 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer; and 100 to 1200 ppm of inhibitor.

Therefore, by virtue of “a quantum dot gel layer including a first polymer and a plurality of quantum dots dispersed in the first polymer” and “the first polymer including: 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer; and 100 to 1200 ppm of inhibitor”, the present disclosure provides a quantum dot gel layer which can omit one side of shielding layer. In other words, the present disclosure provides a quantum dot gel layer with only one side of shielding layer, and an optical film and a backlight module that contain the quantum dot gel layer. The quantum dot gel layer can not only omit a shielding layer, but can also maintain as good a blocking effect against water vapor and oxygen as a structure having two sides of shielding layers.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a sectional view of an optical film according to an embodiment of the present disclosure;

FIG. 2 is a sectional view of the optical film according to another embodiment of the present disclosure;

FIG. 3 is a sectional view of the optical film according to yet another embodiment of the present disclosure;

FIG. 4 is a flowchart of a manufacturing method of the optical film according to an embodiment of the present disclosure;

FIG. 5 is a flowchart of the manufacturing method of the optical film according to another embodiment of the present disclosure; and

FIG. 6 is a sectional view of a backlight module according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

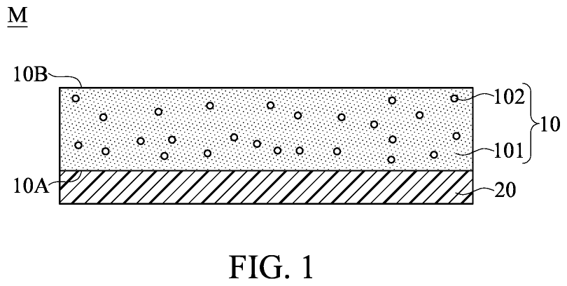

Referring to FIG. 1 to FIG. 3, a first embodiment of the present disclosure provides an optical film M that includes a quantum dot gel layer 10 and a shielding layer 20 disposed on the quantum dot gel layer 10. More specifically, the quantum dot gel layer 10 includes a first polymer 101 and a plurality of quantum dots 102 dispersing in the first polymer 101. Further, the quantum dot gel layer 10 has a first side 10A and a second side 10B, the shielding layer 20 disposed on the first side 10A of the quantum dot gel layer 10, and the second side 10B of the quantum dot gel layer 10 is not covered.

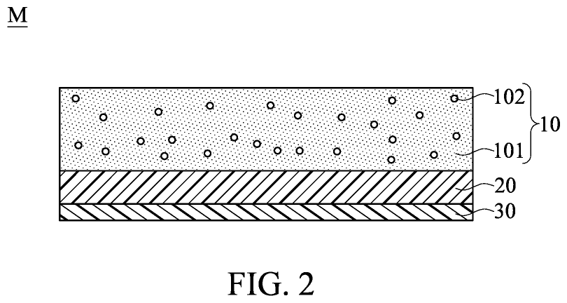

Referring to FIG. 2, the optical film of the present disclosure further includes a matte treated layer 30 disposed on the shielding layer 20, so that the shielding layer 20 is arranged between the quantum dot gel layer 10 and the matte treated layer 30.

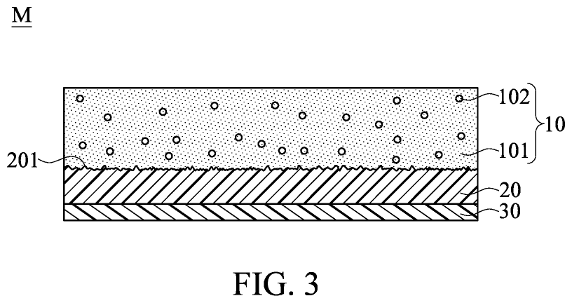

Referring to FIG. 3, the shielding layer 20 of the present disclosure includes a chemical treated surface 201, and the shielding layer 20 is disposed on the quantum dot gel layer 10 by the chemical treated surface 201.

Specifically, a thickness of the quantum dot gel layer 10 is about 30 to 50 μm, a thickness of the shielding layer 20 is about 20 to 30 μm, and a thickness of the matte treated layer 30 is about 3 to 5 μm.

Furthermore, detailed descriptions of the composition and ratio of the quantum dot gel layer are as follows. The quantum dot gel layer includes a first polymer and a plurality of quantum dots dispersed in the first polymer, in detail, the quantum dot gel layer includes 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer, and 100 to 1200 ppm of inhibitor. It should be noted that based on a total weight of the quantum dot gel layer being 100 weight percent, a total weight of a mixture of the photoinitiator, the scattering particles, the thiol compound, the monofunctional acrylic monomer, the multifunctional acrylic monomer and the oligomer is 100% by weight, and then 100 to 1200 ppm of the inhibitor is added.

The photoinitiator is selected from a group consisting of 1-hydroxycyclohexyl phenyl ketone, benzoyl isopropanol, tribromomethyl benzene sulfide and diphenyl (2,4,6-trimethylbenzoyl) phosphine oxide. The scattering particle is a surface-treated acrylic or silicon dioxide or polystyrene beads, and has a particle size from 0.5 to 20 μm. However, the quantum dot gel layer is difficult to cure when the content of the photoinitiator is less than 1 wt %, and the volatility of the overall properties of the gel layer is affected when the content of the photoinitiator is more than 5 wt %.

The scattering particle is surface-treated microbeads and has a particle size from 0.5 to 10 μm, in which the material of the microbeads can be acrylic, silicon dioxide, germanium dioxide, titanium dioxide, zirconium dioxide, aluminum oxide or polystyrene. The refractive index of the scattering particle is about 1.39 to 1.45. The scattering particles provide better light scattering for the quantum dots, so that the light passing through the quantum dot gel layer is more uniform. When the content of the scattering particles is less than 5 wt %, the haze will be insufficient, and when the content of the scattering particles exceeds 40 wt %, the haze will be too much, which results in an overall insufficiency of the material resin content, affecting dispersibility and increasing processing difficulty.

Specifically, the thiol compound is selected from a group consisting of 2, 2′-(ethylenedioxy)diethyl mercaptan, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate. The thiol compound is a non-aromatic compound containing a sulfhydryl functional group (—SH), which provides a functional group with better binding properties to the quantum dot, so that the quantum dot has better dispersibility. However, the above-mentioned effect is not achieved when the content of the thiol compound is less than 5 wt %, and the gel layer becomes too soft and easily bent when the content of the thiol compound exceeds 40 wt %.

The monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate.

The multifunctional acrylic monomer is selected from a group consisting of trimethylolpropane triacrylate, trimethylolpropane trimethacrylate, ethoxylated (20) trimethylolpropane triacrylate, and pentaerythritol triacrylate.

The oligomer is a short chain oligomer with hydrophobic group(s), and is selected from a group consisting of polycarbonate acrylate, urethane acrylate, and polybutadiene acrylate. The oligomer with hydrophobic group(s) has steric barriers, hydrophobicity, thereby providing a better water vapor and oxygen resistance effect, and further providing a water vapor and oxygen resistance capability to the quantum dot gel layer. Compared with the conventional art, one side of the shielding layer can be omitted in the optical film of the present disclosure, that is to say, only one side of the quantum dot gel layer requires a shielding layer to be disposed thereon. Therefore, the thickness of the optical film can be effectively reduced. However, the effect of water vapor and oxygen resistance is not good when the content of the oligomer is less than 15 wt %, and processability is affected when the content of the oligomer exceeds 30 wt %.

The inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol, triaryl phosphines, triaryl phosphites, phosphonic acid, and a combination of an alkenyl-phenol and cupferronate salt. The inhibitor can effectively slow down the reaction rate and avoid the mutual influence of the formula in the composition. For example, the thiol compound and multifunctional acrylic monomer are prone to self-react at room temperature. The addition of the inhibitor in the manufacturing method allows for a better processability and a more stable preservation.

Further, a plurality of quantum dots (QDs) includes red quantum dots, green quantum dots, blue quantum dots and any combination thereof. For example, the plurality of quantum dots may be a combination of the red quantum dots and the green quantum dots. The quantum dots have different or the same particle size. In addition, each of the quantum dots may include a core and a shell, and the shell covers the core. In one or more embodiments, the material of the core/shell of the quantum dots may include cadmium selenide (CdSe)/zinc sulfide (ZnS), indium phosphide (InP)/zinc sulfide (ZnS), lead selenide (PbSe)/lead sulfide (PbS), cadmium selenide (CdSe)/cadmium sulfide (CdS), cadmium telluride (CdTe)/cadmium sulfide (CdS) or cadmium telluride (CdTe)/zinc sulfide (ZnS), but the embodiments are not meant to limit the scope of the present disclosure.

Furthermore, both the core and the shell of the quantum dots can be composite materials in Group II-VI, Group II-V, Group III-VI, Group III-V, Group IV-VI, Group II-IV-VI or Group II-IV-V, in which the term “group” refers to element group of the periodic table.

Specifically, the material of the core can be zinc sulfide (ZnS), zinc selenide (ZnSe), zinc telluride (ZnTe), cadmium sulfide (CdS), cadmium selenide (CdSe), cadmium telluride (CdTe), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), gallium selenide (GaSe), indium nitride (InN), indium phosphide (InP), indium arsenide (InAs), indium antimonide (InSb), thallium nitride (TlN), thallium phosphide (TlP), thallium arsenide (TlAs), thallium antimonide (TlSb), lead sulfide (PbS), lead selenide (PbSe), lead telluride (PbTe) or any combination of the above.

The material of the shell can be zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), magnesium oxide (MgO), magnesium sulfide (MgS), magnesium selenide (MgSe), magnesium telluride (MgTe), mercury oxide (HgO), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs), indium antimonide (InSb), thallium nitride (TlN), thallium phosphide (TlP), thallium arsenide (TlAs), thallium antimonide (TlSb), lead sulfide (PbS), lead selenide (PbSe), lead telluride (PbTe) or any combination of the above.

The chemical treated surface can be a water-based coating on the surface of the shielding layer. The water-based coating can include 30 to 70 wt % of solvent, 5 to 15 wt % of isopropyl alcohol (IPA), 5 to 15 wt % of sodium bicarbonate, 5 to 20 wt % of organic acid, and 10 to 30 wt % of acrylic monomer. Preferably, the pH value of the chemical treated surface may be weak acidic, that is, between pH 5.0 and 6.7. Preferably, the thickness of the chemical treated surface is about 0.01 μm to 0.1 μm.

In detail, the acrylic monomer of the chemical treated surface can be, for example, tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

The matte treated layer is a polyurethane (PU) layer. Preferably, the thickness of the matte treated layer is from 0.5 to 10 μm. The shielding layer and the matte treatment layer isolate the quantum dot gel layer from the external environment, prevent the quantum dots from contacting water vapor or oxygen and then being inoperative, and improve the adhesion between the layers.

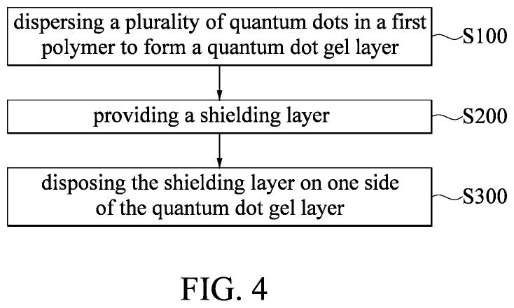

Referring to FIG. 4, the present disclosure further provides a manufacturing method of the optical film, including: S100: dispersing a plurality of quantum dots in the first polymer to form a quantum dot gel layer; S200: providing a shielding layer, and the shielding layer has a chemical treated surface; and S300: disposing the shielding layer on one side of the quantum dot gel layer with the chemical treated surface.

The composition of the first polymer and quantum dots are as described above. More specifically, the dispersing step of S100 includes: firstly, dispersing a plurality of quantum dots in the monofunctional acrylic monomer, adding the inhibitor, then adding the thiol compound, then further adding the multifunctional acrylic monomer, and finally adding the photoinitiator, scattering particles, and oligomer.

In other words, in the step of dispersing a plurality of quantum dots in the first polymer, the plurality of quantum dots is not dispersed in the final mixture of the first polymer, but is sequentially dispersed in certain compositions, other compositions are then added and fully mixed, and a curing step is performed after mixing.

In S200, the shielding layer can be biaxially stretched to have a good flexibility and ductility, and the chemical treated surface is formed by coating the aforementioned water-based coating on one side of the shielding layer, then undergoing the curing step (such as thermal curing or light curing). That is to say, the shielding layer has an outer surface and an inner surface, and the chemical treated surface is formed on the inner surface. Then, S300 is performed: disposing the shielding layer on one side of the quantum dot gel layer with the chemical treated surface, in other words, the inner surface of the shielding layer adjoins to the quantum dot gel layer.

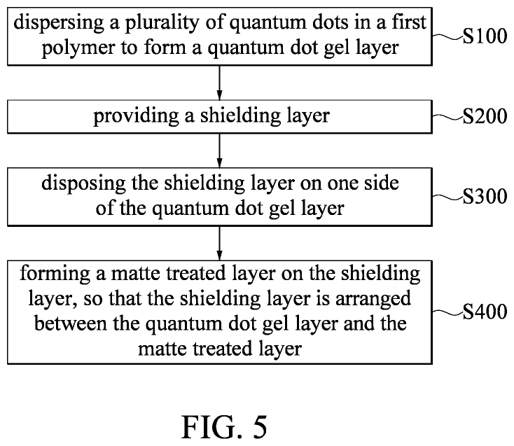

Referring to FIG. 5, the manufacturing method of the optical film of the present disclosure further includes S400: forming a matte treated layer on the shielding layer, so that the shielding layer is arranged between the quantum dot gel layer and the matte treated layer. As above-mentioned, the matte treatment layer is disposed on the outer surface of the shielding layer. This step can be performed before S300: disposing the shielding layer on one side of the quantum dot gel layer.

In addition to the foregoing steps, the manufacturing method of the optical film of the present disclosure further includes: performing a cutting process to cut the optical film into a required size, and performing a winding process to wind the rest of the optical film into a roll for use or storage.

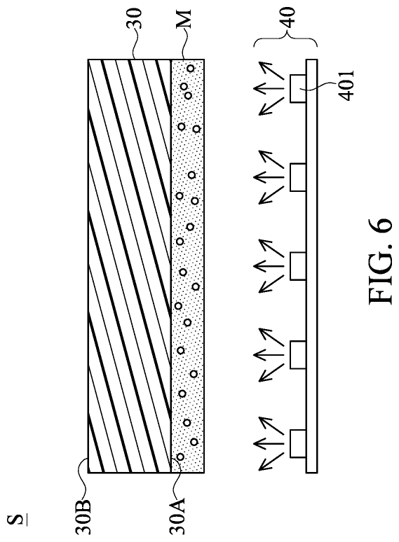

Referring to FIG. 6, the present disclosure further provides a backlight module S that includes a light guide unit 30, at least one light emitting unit 40 and an optical unit M. The light guide unit 30 has a light incident side 30A, and the at least one light emitting unit 40 corresponds to the light incident side 30A, and has a plurality of light emitting units 401. The optical unit M is opposite to the light incident side 30A, and the optical unit M is located between the light guide unit 30 and the at least one light emitting unit 40. In detail, the light guide unit 30 has the light incident side 30A and a light emitting side 30B, and the optical unit M is disposed on the light incident side 30A. More specifically, the optical light unit M is the above-mentioned optical film of the present disclosure, and the quantum glue layer 10 is disposed on the light emitting side 30B of the light guide unit 30. However, the aforementioned description is merely an example and is not meant to limit the scope of the present disclosure.

### EMBODIMENTS

As shown in Table 1, the quantum dot gel layers of embodiment 1, embodiment 2, and comparative embodiment 1 are manufactured according to the following formula and ratio, further obtaining an optical film including a shielding layer, and undergoing the following product property tests. In detail, the following ratio is based on a total weight of the quantum dot gel layer being 100 weight percent, in which the total weight of the photoinitiator, the scattering particles, the thiol compound, the monofunctional acrylic monomer, the multifunctional acrylic monomer and the oligomer is 100 weight percent, and the inhibitor is then added.

TABLE 1

| | | | Comparative |
|---|---|---|---|
| Formula | Embodiment 1 | Embodiment 2 | embodiment 1 |
| Photoinitiator | 3 wt % | 3 wt % | 3 wt % |
| Scattering | 10 wt % | 10 wt % | 10 wt % |
| particles | | | |
| Thiol compound | 20 wt % | 20 wt % | 0 wt % |
| Monofunctional | 20 wt % | 20 wt % | 20 wt % |
| acrylic monomer | | | |
| Multifunctional | 25 wt % | 25 wt % | 35 wt % |
| acrylic monomer | | | |
| Oligomer | 20 wt % | 20 wt % | 30 wt % |
| Quantum dot | 2 wt % | 2 wt % | 2 wt % |
| particles | | | |
| Inhibitor | 1000 ppm | 1000 ppm | 1000 ppm |
| Thickness | 58 μm | 78 μm | 58 μm |
| Water vapor and | under 65° C., and | under 65° C., and | under 65° C., |
| oxygen | 95% relative | 95% relative | and 95% relative |
| resistance | humidity, 0% of | humidity, 0% of | humidity, 12% of |
| | brightness lost | brightness lost | brightness lost |
| | after 1000 hours | after 1000 hours | after 1000 hours |
| | of running | of running | of running |
| | x, y chromaticity | x, y chromaticity | x, y chromaticity |
| | shift 0.0040 | shift 0.0040 | shift 0.0160 |
| Light | 90% | 88% | 85% |
| permeability | | | |
| Refractive index | 1.55 | 1.55 | 1.49 |
| Mechanical | foldable | foldable | non-foldable, |
| properties | | | Maximum |
| | | | bending |
| | | | angle <70 |
| | | | degrees |
| Contractility | 31 ppm/° C. | 31 ppm/° C. | 34 ppm/° C. |
| Brightness | 620 Cd/m2 | 660 Cd/m2 | 490 Cd/m2 |

### Beneficial Effects of the Embodiments

In conclusion, by virtue of “a quantum dot gel layer, including a first polymer and a plurality of quantum dots dispersed in the first polymer” and “the first polymer including: 1 to 5 wt % of photoinitiator, 3 to 20 wt % of scattering particles, 5 to 40 wt % of thiol compound, 5 to 30 wt % of monofunctional acrylic monomer, 10 to 30 wt % of multifunctional acrylic monomer, 15 to 30 wt % of oligomer; and 100 to 1200 ppm of inhibitor”, the present disclosure provides a quantum dot gel layer, and an optical film and a backlight module which contain the quantum dot gel layer, the quantum dot gel layer being capable of omitting one side of shielding layer. In other words, the quantum dot gel layer is provided with only one shielding layer disposed on one side of the quantum dot gel layer.

More specifically, the thiol compound is a non-aromatic compound of a sulfhydryl functional group (—SH) with better binding properties to the quantum dot, so that the quantum dot has better dispersibility. Further, the oligomer of the present disclosure has hydrophobic group(s) thereby providing structural steric barriers, hydrophobicity, and better water and oxygen resistance effect, and further provides water and oxygen resistance property to the quantum dot gel layer. Compared with the conventional art, in the present disclosure, one side of the shielding layer can be omitted, that is to say, only one side of the quantum dot gel layer requires a shielding layer to be disposed thereon. Therefore, the thickness of the optical film can be effectively reduced to about 58 to 80 μm, and the mechanical strength of the optical film can still be maintained at this thickness, allowing the optical film to be applied to general white light backlight modules for mobile phone products.

In addition, when mixing the composition of the present disclosure, the issue of mutual influence should be particularly noted. Therefore, after various experiments, the present disclosure has selected a group of specific inhibitors, which can effectively slow down the reaction rate and avoid self-reaction between the thiol compound and the multifunctional acrylic monomer at room temperature, and further provide better processability and stable storage. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical film, comprising:
a quantum dot gel layer including a first polymer and a plurality of quantum dots dispersed in the first polymer; and
a shielding layer disposed on the quantum dot gel layer;
wherein, based on a total weight of the quantum dot gel layer being 100 weight percent, the first polymer includes:
1 to 5 wt % of photoinitiator;
3 to 20 wt % of scattering particles;
5 to 40 wt % of thiol compound;
5 to 30 wt % of monofunctional acrylic monomer;
10 to 30 wt % of multifunctional acrylic monomer;
15 to 30 wt % of oligomer; and
100 to 1200 ppm of inhibitor.

2. The optical film according to claim 1, wherein the shielding layer further includes: a chemical treated surface, and the shielding layer is disposed on the quantum dot gel layer through the chemical treated surface.

3. The optical film according to claim 1, further including: a matte treated layer disposed on the shielding layer, so that the shielding layer is arranged between the quantum dot gel layer and the matte treated layer.

4. The optical film according to claim 1, wherein the thiol compound is selected from a group consisting of 2, 2′-(ethylenedioxy)diethyl mercaptan, 2, 2′-thiodiethanethiol, trimethylolpropane tris(3-mercaptopropionate), poly(ethylene glycol) dithiol, pentaerythritol tetrakis(3-mercaptopropionate), ethylene glycol bis-mercaptoacetate, and ethyl 2-mercaptopropionate.

5. The optical film according to claim 1, wherein the monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate; wherein the multifunctional acrylic monomer is selected from a group consisting of trimethylolpropane triacrylate, trimethylolpropane trimethacrylate, ethoxylated (20) trimethylolpropane triacrylate, and pentaerythritol triacrylate.

6. The optical film according to claim 1, wherein the oligomer is selected from a group consisting of polycarbonate acrylate, urethane acrylate, and polybutadiene acrylate.

7. The optical film according to claim 1, wherein the inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol triaryl phosphines, triaryl phosphites, phosphonic acid, and a combination of an alkenyl-phenol and cupferronate salt.

8. A manufacturing method of an optical film, comprising:
dispersing a plurality of quantum dots in a first polymer to form a quantum dot gel layer; and
providing a shielding layer having a chemical treated surface, wherein the shielding layer is disposed on one side of the quantum dot gel layer through the chemical treated surface;
wherein, based on a total weight of the quantum dot gel layer being 100 weight percent, the first polymer includes:
1 to 5 wt % of photoinitiator;
3 to 20 wt % of scattering particles;
5 to 40 wt % of thiol compound;
5 to 30 wt % of monofunctional acrylic monomer;
10 to 30 wt % of multifunctional acrylic monomer;
15 to 30 wt % of oligomer; and
100 to 1200 ppm of inhibitor.

9. The manufacturing method according to claim 8, further comprising: forming a matte treated layer on the shielding layer, so that the shielding layer is arranged between the quantum dot gel layer and the matte treated layer.

10. A backlight module, comprising:
a light guide unit having a light entrance side;
at least one light emitting unit corresponding to the light entrance side; and
an optical unit corresponding to the light entrance side and disposed between the light guide unit and the at least one light emitting unit, the optical unit including:
a quantum dot gel layer including a first polymer and a plurality of quantum dots dispersed in the first polymer; and
a shielding layer disposed on the quantum dot gel layer;
wherein, based on a total weight of the quantum dot gel layer being 100 weight percent, the first polymer includes:
1 to 5 wt % of photoinitiator;
3 to 20 wt % of scattering particles;
5 to 40 wt % of thiol compound;
5 to 30 wt % of monofunctional acrylic monomer;
10 to 30 wt % of multifunctional acrylic monomer;
15 to 30 wt % of oligomer; and
100 to 1200 ppm of inhibitor.
